(19) United States
(12) Patent Application Publication
(10) Pub. No.: US 2014/0015894 A1
(43) Pub. Date: Jan. 16, 2014

(54) IN-LINE AQUEOUS COATING SOLUTION FOR SOLID INK JET WEB PRINTING

(71) Applicants: Gordon SISLER, St. Catharines (CA); Guiqin SONG, Milton (CA)

(72) Inventors: Gordon SISLER, St. Catharines (CA); Guiqin SONG, Milton (CA)

(73) Assignee: XEROX CORPORATION, Norwalk, CT (US)

(21) Appl. No.: 13/548,974

(22) Filed: Jul. 13, 2012

(51) Int. Cl. B41J 2/015; C08K 3/36; C08K 5/01; C09D 113/02

(52) U.S. Cl. 347/20; 524/561; 524/493; 524/481

(57) ABSTRACT

Coating compositions and their systems for protecting solid ink jet (SIJ) ink images printed on a substrate are provided by incorporating surfactants and colloidal silicas in overprint coating compositions for reducing or eliminating wetting defects of the coating compositions and for providing adhesion of dried coating compositions with the printed substrate having a low surface tension.

### FIELD OF DISCLOSURE

The present disclosure relates to overprint coating compositions and coatings for application to solid or phase change solid ink jet (SIJ) ink images. More particularly, the present disclosure relates to overprint coating compositions containing surfactants and adhesion agents to provide improved wetting of the coating compositions and adhesion of the coatings on printed solid SIJ ink images.

### BACKGROUND

Solid or phase-change SIJ ink printing eliminates the need for a liquid vehicle enabling SIJ ink penetration and adhesion to the substrate. It is, however, customary to employ a spreading device, such as a two roll nip delivering heat and pressure, to consolidate and improve adhesion of the printed image. Spreading devices may or may not employ a release agent, such as silicone oil, to prevent SIJ ink offset, and the resulting printed SIJ ink images may or may not contain a surface residue of spreader release agent.

Solid SIJ ink jet (SIJ) printing provides applications that SIJ ink jet prints are subjected to friction, wear, rub, and abrasion at various process stages, e.g., in mail inserters and postal sorting operations. These operations require SIJ images of sufficient image robustness.

Current methods for increasing image robustness include forming a protective coating layer over prints. Overprint coatings are commonly employed in offset, flexographic and digital printing to enhance image quality and improve robustness. A distinction is made between in-line and off-line overprint coating, referring to the time delay between printing and application of the liquid film coating. For in-line coating the time delay is in the approximate range 50 ms to 300 s. It is well-known that for in-line overprint coating of xerographic images the presence of fuser release agents requires modifications to coating formulations. As described in U.S. Pat. No. 7,939,176, wetting defects (e.g., pinholes, de-wet retractions, and cratering) can be reduced or removed by incorporating suitable surfactants as coating additives in the overprint coating compositions. It is shown here that for the case of wax-based or wax-containing phase-change SIJ inks the similar issue of contamination of the print surface with thin films of spreader release agent is more challenging for in-line overprint coating than in the xerographic case. This is because the difficulty of uniformly wetting a low surface energy contaminated surface is compounded by the challenge, well-known to practitioners in the art, of dry film adhesion to a waxy surface. As a result, it was observed that coatings modified by surfactants failed to adhere to the SIJ ink images, as dried coatings were easily removed, for example, with Scotch tape.

It is therefore desirable to provide coating compositions having wetting and lay-down uniformity and coatings having acceptable adhesion to the underlying SIJ ink images. It is also desirable to provide an in-line printing system and/or method for applying coating compositions to form coatings over the SIJ ink images printed on a substrate.

### SUMMARY

According to embodiments illustrated herein, there is provided inventive coating compositions and coatings, containing surfactants and adhesion agents, which provide improved wetting and adhesion on SIJ ink images with or without a release agent thereon.

In particular, the present embodiments provide a coating composition for application over a printed substrate. The coating composition can include a latex dispersion, a wax, at least one surfactant, and colloidal silica. The colloidal silica can include a plurality of silica particles present in the coating composition in an amount such that the coating composition is sufficiently adhesive to the printed substrate comprising a solid ink jet (SIJ) ink image when dried.

In further embodiments, there is provided a coating composition, coated on a printed substrate having a low surface tension ranging from about 15 mN/m to about 35 mN/m. The coating composition can include a latex dispersion, a wax, at least one surfactant, and colloidal silica. The coating composition can have substantially no pinholes on the printed substrate. The coating composition, when dried, is sufficiently adhesive to the printed substrate having the low surface tension.

In yet other embodiments, there is provided an in-line printing system for creating durable solid ink jet (SIJ) ink images. The system can include a spreader configured in an SIJ inkjet printing system to pass through a printed substrate. The printed substrate can have SIJ ink images on a substrate with a film of release agent applied at least on the SIJ ink images of the printed substrate. The printed substrate can have a low surface tension ranging from about 15 mN/m to about 35 mN/m. The system can also include a liquid film coating device configured to apply a coating composition to the printed substrate. The coating composition can include a surfactant and a colloidal silica such that the coating composition has substantially no pinholes on the printed substrate and a dried coating composition is sufficiently adhesive to the printed substrate having the low surface tension.

### BRIEF DESCRIPTION OF THE DRAWINGS

For a better understanding of the present embodiments, reference may be had to the accompanying figures.

FIG. 1 depicts time dependence of release oil on print when wax-based solid ink and functionalized silicone release oil are employed.

FIGS. 2A-2C are images of conventional overprint coatings applied to a SIJ/spreader oil solid black image.

FIG. 3 depicts an in-line printing-coating system/method in accordance with various embodiments of the present teachings.

FIG. 4 depicts wetting problems when using a conventional overprint coating composition.

FIG. 5 depicts a surfactant screening experiment, in accordance with various embodiments of the present teachings.

FIG. 6A depicts a printed substrate having no coatings thereon.

FIG. 6B depicts a printed substrate having a coating thereon, the coating containing a surfactant.

FIG. 6C depicts an exemplary printed substrate having a coating thereon, coating containing both a surfactant and a colloidal silica, in accordance with various embodiments of the present teachings.

FIG. 6D depicts another exemplary printed substrate having a coating thereon, the coating containing both a surfactant and a colloidal silica, in accordance with various embodiments of the present teachings.

### DETAILED DESCRIPTION

In the following description, it is understood that other embodiments may be utilized and structural and operational changes may be made without departure from the scope of the present embodiments disclosed herein.

Various embodiments provide coating compositions containing surfactant(s) and adhesion agent(s) such as colloidal silica over a printed substrate including solid ink jet (SIJ) ink images printed on one or both sides of a substrate. The printed substrate containing SIJ ink images may have low surface tension due to the oily wax nature of the SIJ ink images and/or contamination of spreader release agents applied on at least the SIJ ink images during printing. The disclosed coating compositions applied on the printed substrate having low surface tension may be substantially free from wetting defects, for example, no pinholes, craters or retractions. The resulting coatings, i.e., dried from the coating compositions, may be sufficiently adhesive to the printed substrate having a waxy surface and spreader release agent related low surface tension.

As used herein, the term “sufficiently adhesive” refers to measurement according to a number of standard tests, e.g., ISO 16276-2, which refers to x-cut tape peel evaluation of paint adhesion to steel, but similarly applies to coatings on printing substrates according to ASTM D3359-97. These tests involve inscribing a pattern of x-cuts or cross-hatches on the coating layer then adhering and removing a piece of tape in a controlled manner to examine the subsequent extent of coating film damage and removal. Evaluation is typically based on a visual ranking against a set of reference samples. A significant challenge of this type of test is ensuring consistent tape material tack and controlling tape adhesion and removal, met in this disclosure by using a Lintview tape peel tester supplied by Labtech Instruments.

In embodiments, SIJ ink images may be printed on a substrate, such as, for example, paper, plastic, or other printable materials. The substrate may be uncoated, gloss coated, cast coated, matte, or silk or is coated solid bleached sulphate (SBS) packaging. The printed substrate may have a low surface tension, contributed by SIJ ink images and/or release agents on the SIJ ink images, ranging from about 15 mN/m to about 35 mN/m, or from about 19 mN/m to about 25 mN/m, or from about 19 mN/m to about 23 mN/m, at a temperature of about 20° C.-25° C.

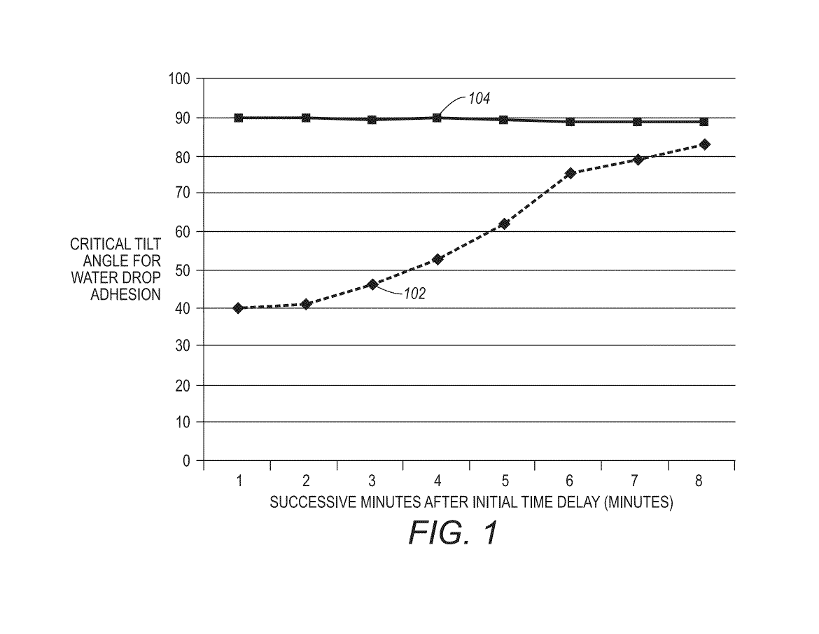

FIG. 1 depicts time dependence of oil on print, when wax-based solid ink and functionalized silicone release oil are employed in Xerox CiPress 500. Plot 102 is measured 5 minutes after printing, while plot 104 is measured 30 minutes after printing. When measuring, DI water is used at about 23° C. using an FTA200 with a tilt stage. FIG. 1 indicates that the critical tilt angle (sliding angle for water drop on print surface) changes rapidly for the plot 102 (measured 5 minutes after printing), but is constant for the plot 104 (measured 30 minutes after printing). In the first 13 minutes following printing and spreading, the release oil applied interacts with the solid ink surface through diffusion, wetting, spreading and capillary penetration, this significantly effects the uniform wetting and lay-down of aqueous coatings applied in-line as liquid films. The disclosed coating compositions, containing surfactants and adhesion agents such as colloidal silicas, provide uniform wetting and lay-down properties as well as desired adhesion with the underlying SIJ ink images (with or without a film of release agents) printed on the substrate.

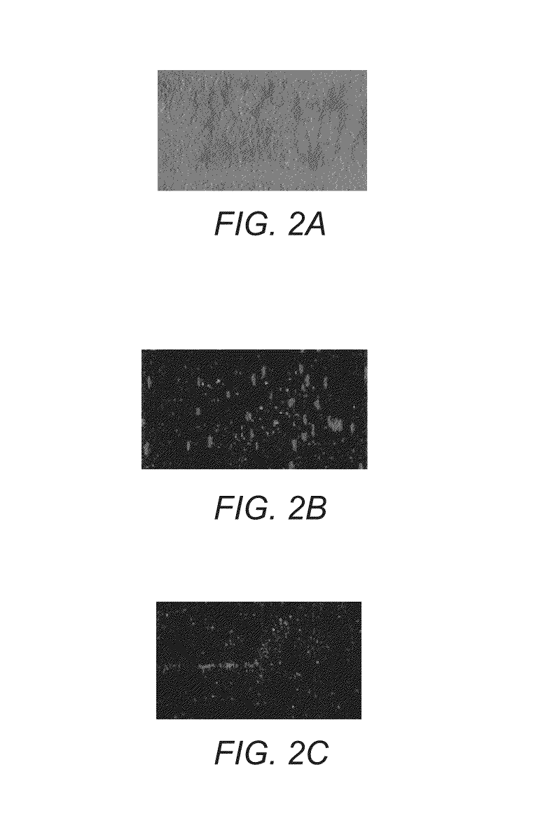

A prolonged time delay after printing and spreading facilitates the uniform lay-down of aqueous liquid film overprint coatings. This is illustrated in FIGS. 2A-2C. The image of FIG. 2A is a micrograph of an overprint coating applied to a SIJ/spreader oil solid black image 10 minutes after printing; the levels of the photograph have been manipulated to highlight the severe wetting non-uniformity. The micrograph in FIG. 2B is an identical SIJ/spreader oil image coated 120 minutes after printing, with the same level adjustment, demonstrating the effect of prolonged time delay to ensure uniform coating wetting and lay-down. If in-line coating is required, as is often the case for production printing, it is possible to identify suitable surfactants which, incorporated into the coating formulation, deliver uniform coating lay-down at short time delays. The micrograph of FIG. 2C illustrates this for one suitably surfactant-adjusted formulation coated 10 minutes after SIJ printing/spreading. The surfactant reduces the surface tension of the liquid coating to a range of values in the neighborhood of that for the heterogeneous low surface energy wax/oil print image, as discussed for example in a related context in U.S. Pat. No. 7,939,176. It is well-known to practitioners in this field that lowering surface tension is a necessary but not sufficient condition of uniform wetting.

There are two basic challenges of coating the type of surface represented by wax covered by a thin, discontinuous film of silicone oil. First, the challenge of uniform wetting and lay-down discussed in the previous paragraph, which in the case of in-line coating of SIJ prints can be resolved by incorporating suitable surfactants in coating formulation. Second, the additional challenge of achieving adequate adhesion of the coating film after it has dried. It is well known that the chemistry of wax-based materials impedes adhesion of coated films; however it is possible to identify latex-based coatings that adhere sufficiently to wax-based SIJ prints when coating occurs off-line, i.e., after a sufficient time delay to allow oil dissipation. When those same latex-based coatings, modified with suitable surfactants to ensure uniform wetting and lay-down, are coated in-line, the subsequent adhesion is poor, e.g., complete removal of coating film may occur with standard tape test. The loss of adhesion may be due to presence of oil on wax or surfactant addition to coating or an interaction between these factors. Conventionally, it was unable to identify a coating with sufficient adhesion off-line that met the criteria for adhesion once modified for in-line coating. Therefore a requirement was identified to provide an additional modification to re-establish sufficient adhesion for in-line coatings. The solution disclosed in this disclosure is the addition of exemplary colloidal silica to the overprint coating formulation for the purpose of establishing sufficient adhesion in in-line applications. The use of colloidal silica in a wide range of latex-based coatings is established for its ability to improve properties such as coefficient of friction, toughness and abrasion resistance. Amorphous colloidal silica is rich in hydroxyl ions at the surface, which can be destabilized from a colloidal dispersion to form a gel structure and also cross link with the latex polymers. Additionally colloidal silica presents a very porous receptive surface making it a desirable pigment in, for example, photo-paper for aqueous ink jet printing.

In embodiments, the disclosed coating compositions may include at least one latex dispersion, at least one wax, at least one surfactant, and/or at least one adhesion agent such as colloidal silica.

Latex Dispersion

The latex dispersion may include any suitable latex resin material or known latex resin material including, for example, acrylic including styrene acrylic, vinyl acetate, ethylene vinyl acetate, polyesters, sulfonated polyesters, styrene butadienes, and the like polymers, and mixtures thereof. In embodiments, the latex material may be copolymers or crosslinked polymers.

In exemplary embodiments, the latex material may be a copolymer including styrene and an acrylic ester. For example, the styrene may include a-methyl styrene, 3-chlorostyrene, 2,5-dichlorostyrene, 4-bromostyrene, 4-tert-butylstyrene, 4-methoxystyrene, vinyl naphthalene, vinyl toluene, divinyl benzene or a combination thereof.

The acrylic ester of the exemplary latex copolymer may have an alkyl group with three or fewer carbon atoms. For example, the acrylic ester may include acrylic esters and methacrylic esters. The acrylic ester may therefore be propyl acrylate, propyl methacrylate, ethyl acrylate, ethyl methacrylate, methyl acrylate, methyl methacrylate or mixtures thereof. In other embodiments, the acrylic ester of the exemplary latex copolymer may be an aromatic acrylic ester. Exemplary aromatic acrylic ester monomers may include benzyl acrylate, phenyl acrylate, phenethyl acrylate, benzyl methacrylate, or a combination thereof.

Exemplary latex dispersions and/or other components in the coating compositions may include those described in commonly assigned U.S. Pat. No. 7,939,176, the contents of which are incorporated herein by reference in their entirety. For example, acrylic latex dispersions may include poly(alkyl methacrylate-alkyl acrylate), poly(alkyl methacrylate-aryl acrylate), poly(aryl methacrylate-alkyl acrylate), poly(alkyl methacrylate-acrylic acid), and poly(alkyl acrylate-acrylonitrile-acrylic acid); the latex contains a resin selected from the group consisting of poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene) and poly(butyl acrylate-isoprene).

Examples of styrene/acrylic latex dispersions may include poly(styrene-alkyl acrylate), poly(styrene-1,3-diene), poly(styrene-alkyl methacrylate), poly(styrene-alkyl acrylate-acrylic acid), poly(styrene-1,3-diene-acrylic acid), polystyrene-alkyl methacrylate-acrylic acid), poly(styrene-alkyl acrylate-acrylonitrile-acrylic acid), and poly(styrene-1,3-diene-acrylonitrile-acrylic acid); the latex contains a resin selected from the group consisting of poly(styrene-butadiene), poly(methylstyrene-butadiene), poly(styrene-isoprene), poly(methylstyrene-isoprene), poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), and poly(styrene-butyl acrylate-acrylononitrile-acrylic acid).

Examples of specific acrylic latex dispersions suitable for use herein may include RHOPLEX® HA-12 & RHOPLEX® 1-2074 available from Rohm & Haas, Co. and Joncryl 89, Joncryl 60, Joncryl 74, Joncryl 77, Joncryl 624, Joncryl ECO2124, Joncryl HRC1661 from BASF. Examples of styrene/acrylic latex dispersions include ACRONAL S728, ACRONAL NX4533 and ACRONAL S888S from BASF. Water based acrylic or styrene/acrylic dispersions may be self-crosslinking and/or alkali soluble and supplied on the acid side (un-neutralized).

Examples of suitable polyester latex dispersions may include polyethylene-terephthalate, polypropylene-terephthalate, polybutylene-terephthalate, polypentylene-terephthalate, polyhexylene-terephthalate, polyheptadene-terephthalate, polyoctalene-terephthalate, polyethylene-sebacate, polypropylene sebacate, polybutylene-sebacate, polyethylene-adipate, polypropylene-adipate, polybutylene-adipate, polypentylene-adipate, polyhexylene-adipate, polyheptadene-adipate, polyoctalene-adipate, polyethylene-glutarate, polypropylene-glutarate, polybutylene-glutarate, polypentylene-glutarate, polyhexylene-glutarate, polyheptadene-glutarate, polyoctalene-glutarate polyethylene-pimelate, polypropylene-pimelate, polybutylene-pimelate, polypentylene-pimelate, polyhexylene-pimelate, polyheptadene-pimelate, poly(propoxylated bisphenol-fumarate), poly(propoxylated bisphenol-succinate), poly(propoxylated bisphenol-adipate) and poly(propoxylated bisphenol-glutarate).

In embodiments, the latex material may be present in a form of, for example, latex particulates. The latex particles may have an average particle size ranging from about 20 nm to about 500 nm, or from about 50 nm to about 300 nm, or from about 75 nm to about 200 nm, although any suitable latex particulates may be used without limitation.

It is well-understood that latex dispersions are a two phase colloidal system, comprised of polymer particles suspended in water, with suitable surfactants, protective colloids and other additives known to persons skilled in the art. The solids fraction in a latex is between about 30 and about 70, or between about 40 and about 60 or between about 45 and about 50, all expressed as weight solids/total weight on a percentage basis.

In embodiments, the coating composition may include one or more latex dispersions in a total amount from about 40 weight percent to about 95 weight percent, such as from about 50 weight percent to about 90 weight percent or from about 60 weight percent to about 90 weight percent by wet weight of the total weight of the coating composition. If one or more latex dispersions are utilized, each latex dispersion may be present in any ratio between 0 and 100% including the blend as long as the total amount of the latex dispersion in the coating composition is within the desired range.

Waxes

In embodiments, the wax used herein may have a molecular weight (Mw, as measured by Gel Permeation Chromatography) ranging from about 300 to about 5000, or from about 400 to about 4000, or from about 500 to about 3000. In embodiments, the wax may be in a form of fine particles (or powder) or in dispersions having an average particle size ranging from about 10 nanometers to about 10 microns, or from about 50 nanometers to about 5 microns, or from about 100 nanometers to about 2 microns, or from about 200 nanometers to about 1 micron.

Exemplary wax may include, but is not limited to, polyolefins, non-ionic dispersion based on a paraffin wax, non-ionic dispersion based on an oxidized high density polyethylene wax, non-ionic aqueous dispersion of a polytetrafluoroethylene (PTFE) modified polyethylene wax, and combinations thereof.

For example, waxes that may be used include polyolefins such as polyethylene, polypropylene, and polybutene waxes such as commercially available from Allied Chemical and Petrolite Corporation, for example POLYWAX™ like including POLYWAX® 2000, POLYWAX® 1000, POLYWAX® 500, and the like from Baker Petrolite, Inc.; oxidized waxes such as X-2073 and Mekon waxes, from Baker-Hughes Inc.; polyethylene waxes such as from Baker Petrolite, wax dispersions available from BASF such as Joncryl wax 4, Joncryl wax 26, Joncyrl wax 28 and Joncryl wax 120 and from Michaelman, Inc. and the Daniels Products Company, EPOLENE N-15™ commercially available from Eastman Chemical Products, Inc., and VISCOL 550-P™; plant-based waxes, such as carnauba wax, rice wax, maydelilla wax, sumacs wax, and jojoba oil; animal-based waxes, such as beeswax; mineral-based waxes and petroleum-based waxes, such as montan wax, ozokerite, ceresin, paraffin wax, microcrystalline wax, and Fischer-Tropsch wax; ester waxes obtained from higher fatty acid and higher alcohol, such as stearyl stearate and behenyl behenate; ester waxes obtained from higher fatty acid and monovalent or multivalent lower alcohol, such as butyl stearate, propyl oleate, glyceride monostearate, glyceride distearate, and pentaerythritol tetra behenate; ester waxes obtained from higher fatty acid and multivalent alcohol multimers, such as diethyleneglycol monostearate, dipropyleneglycol distearate, diglyceryl distearate, and triglyceryl tetrastearate; sorbitan higher fatty acid ester waxes, such as sorbitan monostearate; and cholesterol higher fatty acid ester waxes, such as cholesteryl stearate.

Examples of functionalized waxes that may be used include amines, amides, for example AQUA SUPERSLIP 6550™, SUPERSLIP 6530™ available from Micro Powder Inc., fluorinated waxes, for example POLYFLUO 190™, POLYFLUO 200™, POLYSILK 19™, POLYSILK 14™ available from Micro Powder Inc., mixed fluorinated, amide waxes, for example MICROSPERSION 19™ also available from Micro Powder Inc., imides, esters, quaternary amines, carboxylic acids or acrylic polymer dispersion, for example JONCRYL 74™, 89™, 130™, 537″, and 538™, all available from BASF, and chlorinated polypropylenes and polyethylenes available from Allied Chemical and Petrolite Corporation and SC Johnson wax; and combinations thereof. Other suitable additives or materials as known to one of ordinary skill in the art may also be included in the wax dispersion.

Waxes supplied for this class of coating formulations are typically two-phase colloidal dispersion including a solid wax material suspended in water with appropriate surfactants, protective colloids, etc. In this case the wax solids fraction can be from about 5 percent to about 40 percent, or from about 10 percent to about 40 percent, or from about 25 percent to about 35 percent by weight of the total dispersion weight.

In embodiments, the coating composition may include one or more wax dispersions in a total amount from about 5 weight percent to about 40 weight percent, such as from about 5 weight percent to about 30 weight percent or from about 10 weight percent to about 20 weight percent by wet weight of the total weight of the coating composition. If one or more wax dispersions is utilized, each wax dispersions may be present in any ratio between 0 and 100% comprising the blend as long as the total amount of the wax dispersion in the coating composition is within the desired range.

Surfactants

At least one surfactant is used to lower the surface tension of coating compositions that are applied to oily wax SIJ ink images and/or release agent-wetted surfaces, to allow wetting and leveling of the oily wax SIJ ink images and/or release agent-wetted surfaces. Any combination of surfactants may be used.

Suitable surfactants for use herein include anionic surfactants, nonionic surfactants, silicone surfactants and fluorosurfactants. Examples of anionic surfactants may include sulfosuccinates, disulfonates, phosphate esters, sulfates, sulfonates, and the like, and mixtures thereof. Examples of nonionic surfactants may include polyvinyl alcohol, polyacrylic acid, isopropyl alcohol, acetylenic diols, octyl phenol ethoxylate, branched secondary alcohol ethoxylates, perfluorobutane sulfonates and alcohol alkoxylates, and the like, and mixtures thereof.

Silicone surfactants may include polyether modified poly-dimethyl-siloxane and the like. The polyether modified polydimethylsiloxanes may include, for example, BYK®-UV3510 (BYK Chemie GmbH, Wesel, Germany), and BYV-348 (BYK Chemie GmbH), such as, for example, BYK®-UV3510 (BYK Chemie GmbH, Wesel, Germany) and BYK®-348 (BYK Chemie GmbH), and fluorosurfactants, such as, for example, Zonyl® FSO-100 (E.I. Du Pont de Nemours and Co., Wilmington, Del.), having the formula R_{f}CH₂CH₂—O—(CH₂CH₂O)ₓH, wherein R_{f} is F(CF₂CF₂)_{y}, x=0 to about 15, and y=1 to about 7.

Fluorosurfactants may include anionic, cationic, amphoteric and nonionic fluorinated surfactants, for example, fluorinated alkyl esters. Other examples of fluorosurfactants suitable for use herein may include Innovative Chemical Technologies Inc. water soluble short-chain nonionic fluorosurfactant FS 8050. ZONYL® FSO-100 (E.I. Du Pont de Nemours and Co., Wilmington, Del.), having the formula R_{f}CH₂CH₂—O—(CH₂CH₂O)ₓH, wherein R_{f} is F(CF₂CF₂)_{y}, x=0 to about 15, and y=1 to about 7, FLUORADS® FC430, FC170C, FC171, and the like, available from 3M.

Consistent with earlier discussion of latex and wax components of the coating it is well-known that the surfactant materials utilized are single-phase materials, therefore having no solids fraction and expressible simply as wet weight addition. This additional surfactant is not inclusive of the surfactant that may be included in the latex dispersions.

The coating composition may include one or more surfactants in a total amount from about 0.001 weight percent to about 5 weight percent, such as from about 0.01 weight percent to about 3 weight percent or from about 0.1 weight percent to about 1 weight percent, based on the weight of the total coating composition. The total amount of surfactants in the coating composition refers to the surfactant added to the coating composition, not to any surfactant found in the latex dispersions. In other words, the amount of total surfactant is not inclusive of any surfactant that may be included in the latex dispersions.

Adhesion Agents

As disclosed herein, colloidal silicas may be used as adhesion agents and may be suspensions of a plurality of silica particles in a liquid phase. The silica particles may be, for example, fine amorphous and nonporous silica particles. The silica particles may be spherical or non-spherical (e.g., plate-shaped) having average particle sizes, measured by Malvern particle size analyzer, ranging from about 1 nm to about 1000 nm, or from about 5 nm to about 500 nm, or from about 10 nm to about 100 nm. Colloidal silicas may exhibit particle densities in the range from about 1.05 g/cm³ to about 1.45 g/cm³, or from about 1.1 g/cm³ to about 1.35 g/cm³, or from about 1.15 g/cm³ to about 1.25 g/cm³. Colloidal silicas may be obtained from an aqueous silicic acid solution. In addition, in view of dispersibility, a dispersing medium used in the colloidal particles may be water, although other medium may be used without limitation. The colloidal silica may include, but is not limited to, SNOWTEX® OL colloidal silica, SNOWTEX® OS colloidal silica, SNOWTEX® ST-50 colloidal silica, Eka Chemicals Bindzil® IJ100, Bindzil® IJ200 and/or mixtures thereof.

Colloidal silica utilized in these coatings is a two-phase colloidal dispersion comprising silica particles dispersed in water with the addition of surfactants, etc required to impart colloidal stability and other additives. In this case the silica solids fraction is between 5 and 55 percent or from 30-55 percent or between 40 and 50 percent expressed on total dispersion weight.

The colloidal silica may be present in the coating composition in an amount ranging from about 1 percent to about 25 percent, or from about 5 percent to about 20 percent, or from about 8 percent to about 15 percent, expressed as wet weight silica dispersion on total weight coating composition, such as, for example, about 10 percent wet weight of the total coating composition, such that a coating formed of the dried coating composition is sufficiently adhesive to the printed substrate having the low surface tension as disclosed herein.

The components of the overprint coating formulation are associated in the wet or aqueous state in a well-understood manner characteristic of multi-component colloidal dispersions. All particles, including latex, wax and amorphous silica, being colloidal in size, are stabilized through electrical double layers associated with surface charges on the particle and dissolved ionic species. In addition surfactants play a role in colloidal stabilization through their participation in the aqueous phase and association with particles. In some embodiments soluble cobinders are present in the aqueous phase. The interaction of particles and surface active materials, both those added functionally for purposes of improved wetting, and those integral to the stability of wax and latex dispersions, must be determined experimentally. After liquid film coating application the coating loses water content, bringing particles into closer proximity and destabilizing colloidal association, so that viscosity increases and film formation begins to occur in the manner well-understood for this class of coatings, associated with surface tension and capillary forces. The extent of interaction between the components latex, wax and surfactant as the coating film dries varies in different embodiments. In some embodiments the wax and latex particles are associated through van der Waals type forces. In other embodiments hydrogen bonds may play a role, and in those embodiments employing a cross-linking mechanism covalent bonds are present. It is also the case that in some embodiments the colloidal silica may be cross-linked forming covalent bonds with latex particles, as well as associated with latex and wax through van der Waals and hydrogen bond type of attractions.

In embodiments, in addition to latex dispersions, waxes, surfactants, and colloidal silicas, the coating compositions may include known soluble polymer cobinders, for example, soluble acrylic resins or polyvinyl alcohol and/or other coating additives, for example, cross-linking agents, lubricants, humectants, anti-oxidants, etc. The viscosity of the coating compositions in embodiments may be, for example, from about 200 cP to about 2000 cP, or from about 200 cP to about 1500 cP, or from about 300 cP to about 800 cp, at a temperature ranging from about 20° C. to about 30° C.

In embodiments, a liquid thin film coating process may be used to apply the exemplary aqueous coating compositions over at least SIJ ink images on a substrate, followed by a solidifying process, e.g., a drying and/or heating process, to remove water from the coating compositions to form coatings over the printed substrate having low surface tension contributed by SIJ ink images and/or release agents applied thereon.

Various coating techniques may be used to form the disclosed overprint coatings. As used herein, the term “coating technique” refers to a technique or a process for applying, forming, or depositing the coating composition on a material or a surface. Therefore, the term “coating” or “coating technique” is not particularly limited in the present disclosure. Any of numerous methods well-understood in the industry including forward and reverse transfer roll coating, gravure coating, offset gravure coating, blade coating, air-knife coating and rod coating may be employed. In many embodiments offset gravure or anilox flexo or multi-roll film transfer coating techniques are employed.

After the coating composition is coated on desired surface, a drying process may be performed. For example, the coated substrate may be heated at a temperature of less than 100° C., including from about 80° C. to about 160° C. or other suitable temperatures. In many embodiments air-impingement convection drying used but radiation or other drying is also suitable.

Regardless of the manner in which the coating is formed, each dried coating layer may have a thickness, while maintaining sufficient adhesion to the printed substrate with low surface tension. In various embodiments, the coating and drying process may be repeated as desired to achieve a required thickness. For example, the thickness may range from about 0.3 microns to about 10 microns, or from about 0.5 microns to about 7 microns, or from about 0.5 to about 5 microns, while the coating is sufficiently adhesive to the printed substrate having low surface tension and/or substantially with no pinholes. In embodiments, the coating is in an amount from about 0.3 gsm to about 10 gsm, or from about 0.5 gsm to about 7 gsm, or from about 0.5 gsm to about 5 gsm, to the SIJ ink images.

In embodiments, such coating process is integrated into the production line of SIJ inkjet printing process, for example, in a web printing process designed for transactional/promotional printing. This integrated process may be referred herein as “an in-line coating process,” where a coating composition is applied in-line after SIJ ink images are printed onto the substrate, such that the time delay between printing/spreading and application of the liquid film coating is between 50 ms and 300 s.

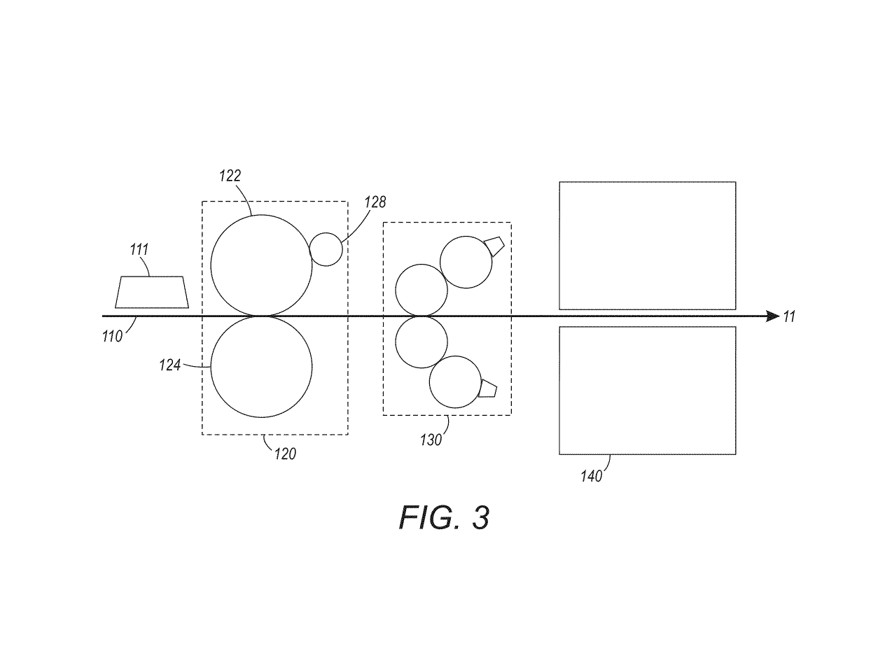

FIG. 3 depicts an inline printing-coating system and method by applying a coating composition over a printed substrate after exiting a spreader system of an SIJ ink jetting process in accordance with various embodiments of the present teachings.

During SIJ ink-jet printing, a continuous web of a substrate including, for example, paper, is supplied from a web unwind station to move through a printing station having a series of print-heads configured to effectively extend across the width of the web and being able to place SIJ ink of one or various colors directly onto the moving web. Solid SIJ ink may be printed on the web to form a printed substrate. Typically, solid SIJ ink may be substantially solid at room temperature and substantially liquid when initially jetted onto the web.

As shown in FIG. 3, along the web transport path in the direction 11, the substrate 110 having SIJ ink image placed thereon at 111 with a suitable temperature may be sent to pass through the spreader 120. The spreader 120 may apply a predetermined pressure, and in some implementations, heat, to the web. The spreader 120 may be functioned to take what are essentially isolated droplets of SIJ ink on web and consolidate them to make a continuous layer by pressure, and, in some embodiments, heat, so that spaces between adjacent drops are filled and image solid uniformity increases. In addition to spreading the SIJ ink, the spreader 120 may also improve image durability by increasing SIJ ink layer cohesion and/or increasing the SIJ adhesion to the substrate. The spreader 120 may include a spreader member 122 and a pressure member 124 that apply heat and/or pressure to the printed substrate 110. Either member (e.g., in a form of roller) may include heat elements (not shown) to bring the web to a desired temperature. The spreader 120 may be a typical spreader as known in the art. The spreader may include an oiling station 128 associated with the spreader member 122, which may be an image-side roller. Spreader release agents may be applied by the oil station 128 to at least the SIJ ink images printed on the substrate. In some cases, an oil-less spreading may be used to treat the jetted SIJ ink images on the substrate 110.

A liquid film coating device 130 may be connected to the spreader 120 and configured to apply a coating composition to the substrate 110 including SIJ ink images and/or a film of spreader release agent thereon, and to subsequently form a coating on the printed substrate. In an in-line coating configuration as shown, the process time delay between spreading unit 120 and coating unit 130 is from about 50 ms to about 300 s, or from about 50 ms to about 120 s, or from about 50 ms to about 10 s. Various coating techniques may be used as disclosed herein. In embodiments, the inline printing-coating system of FIG. 3 may further include a drying station or drying unit 140 configured to dry the coating composition that is applied over the printed substrate 110 using the coating unit 130.

In embodiments, the printing process may involve a duplex marking process capable of producing duplex, or two-sided, prints having a first-side SIJ ink image and a second-side SIJ ink image by an inverter and a duplex loop, although FIG. 3 depicts a one-side printing of a simplex marking system as an example for illustration purpose. In a duplex marking process, the liquid film coating device 130 may be configured to apply coating compositions to at least the SIJ ink images on one or both sides of the substrate to protect SIJ ink images and create durable SIJ ink images. One or both sides of the printed substrate may have a film of the release agent applied thereon and may have a low surface tension. The applied coating compositions may be substantially free of wetting defects and/or may be sufficiently adhered to the surface of one or both sides of the printed substrate, to provide durable SIJ ink images. Durable SIJ images satisfy criteria dependent on end-use functional performance requirements. Numerous tests have been developed to establish quality testing standards matching end-use performance. These reflect durability failure modes such as scratch, rub, abrasion, folding, shear, delamination resistance, etc. There is a great variety of testing methods and standards but in general these printed images must be durable to withstand rubbing, scratching, abrading and folding encountered in high-speed finishing operations well-known in the commercial web printing industry.

The coating compositions, coatings described herein are further illustrated in the following examples. All parts and percentages are by weight unless otherwise indicated. It will be appreciated that a variety of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

While the description above refers to particular embodiments, it will be understood that many modifications may be made without departing from the spirit thereof. The accompanying claims are intended to cover such modifications as would fall within the true scope and spirit of embodiments herein. The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The examples set forth herein below and are illustrative of different compositions and conditions that may be used in practicing the present embodiments. All proportions are by weight unless otherwise indicated. It will be apparent, however, that the present embodiments may be practiced with many types of compositions and may have many different uses in accordance with the disclosure above and as pointed out hereinafter.

The following examples include various coating compositions including a conventional coating composition having no surfactant or colloidal silica (see Comparative Example IA), a coating composition having a surfactant (see Comparative Example IB), and coating compositions having both a surfactant and a colloidal silica (see Examples IIA and IIB).

Fresh prints were generated having 100% Magenta color on a gloss coated paper substrate of 120 gsm Digital Color Elite Gloss by Xerox Phaser 8860 printer equipped to deliver various types of spreader release oil, including amine functionalized silicone oil. The coating compositions were applied using a Mathis Lab Coater with varying wire-wound Meyer rods on prints less than 2 minutes after the fresh prints were generated. The applied coating compositions were dried at a temperature of about 80° C. for about 1 minute.

Two attributes were evaluated on the resulting dried coated prints: first, related to liquid coating film wetting and lay-down uniformity a measure of pinholes or small non-wetting surface tension driven retractions was developed comprising a visual assessment and rating as well as a measurement technique based on image analysis of a digital image (without magnification) of the coated surface. Dry film adhesion to the printed image was measured using a controlled x-cut tape-peel test and with the Lintview instrument as described earlier.

### Example I

### Comparative Example IA

| Component | Wet Weight % | Source |
|---|---|---|
| acrylic latex | 55 | BASF JONCRYL ® 74-A |
| | | (50 wt. % in solid) |
| paraffin/polyethylene | 15 | BASF JONCRYL ® |
| wax | | WAX 28 (38 wt. % in solid) |
| Commercially available | 30 | Coating and Adhesives |
| overcoat composition | | Corporation |

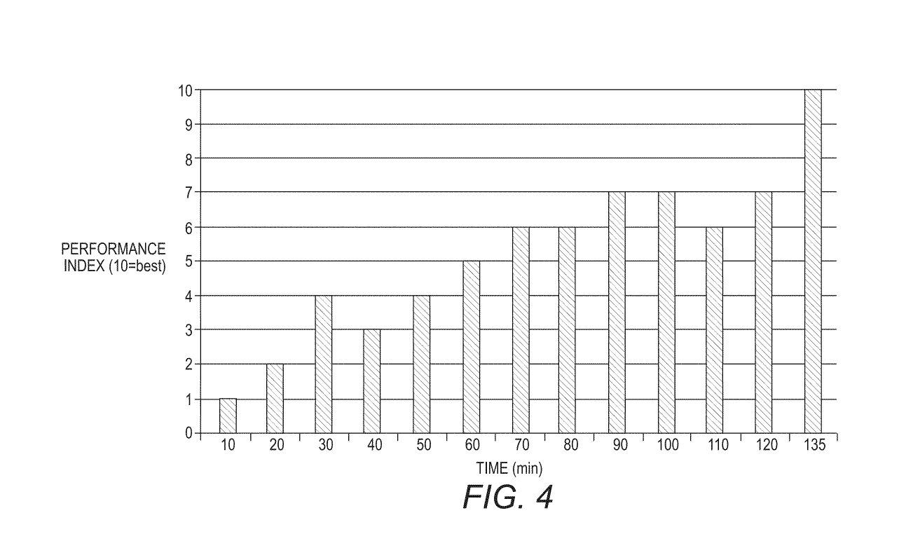

The coating composition of comparative Example IA, containing no surfactant or adhesion agent, was applied on the printed substrate at increasing time intervals after the printing process. FIG. 4 shows the dependence of wetting problems of the coating composition on time delay between printing and coating. The “performance index” is a visual ranking of pinhole density (severity, e.g., number and size, of pinholes per coated area) from 1-10 where 1 represents severe pinhole presence and 10 denotes extremely uniform wetting, free of pinholes. As shown, wetting uniformity after 10 minutes is rated 1, while after approximately 120 minutes the rating improves to 10.

### Comparative Example IB

| Component | Wet Weight % | Source |
|---|---|---|
| acrylic latex | 53.9 | BASF JONCRYL ® 74-A |
| | | (50 wt. % in solid) |
| paraffin/polyethylene | 14.7 | BASF JONCRYL ® |
| wax | | WAX 28 (38 wt. % in solid) |
| Commercially available | 29.4 | Coating and Adhesives |
| overcoat composition | | Corporation |
| Fluorinated surfactant | 2 | Innovative Chemical |
| | | Technologies, Inc. |
| | | Thetawet FS 8050 |

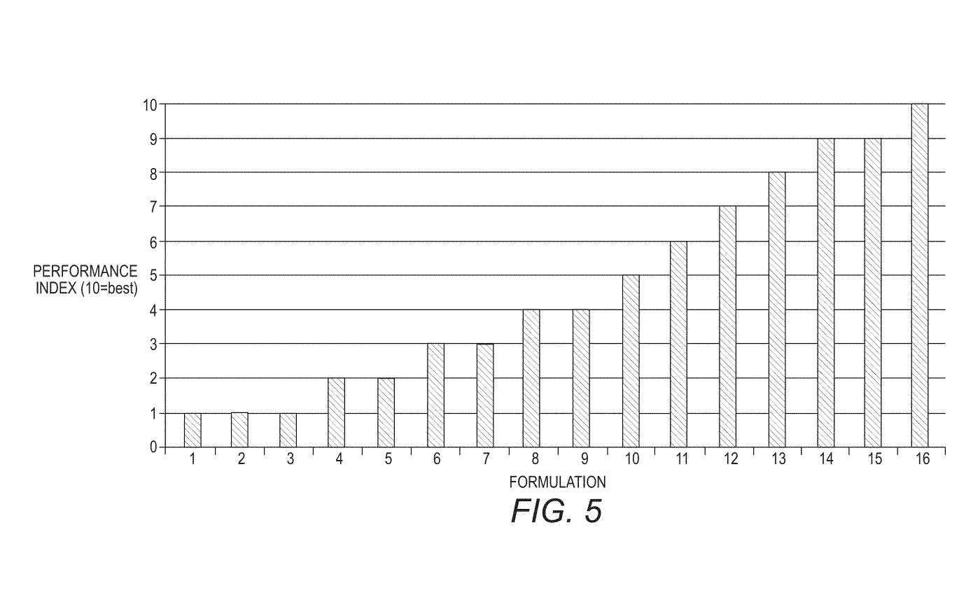

A surfactant screening experiment, including the formulation of comparative Example 1B was conducted. FIG. 5 represents the results for this experiment. In this figure, column 1 on the x-axis is the formulation of comparative Example 1A while columns 2-16 denote combinations of different surfactants and surfactant levels, with comparative Example 1B denoted by column 16 on the x-axis. As indicated earlier the y-axis denotes a visual assessment of pinhole density. The coating composition of comparative Example IB successfully achieves excellent wetting and lay-down uniformity on SIJ prints plus residual spreader oil with coating application less than 2 minutes after printing/spreading. Several other surfactants were also demonstrated to provide satisfactory in-line wetting, performance rating 8 or higher, including Aerosol® OT-75 PG surfactant, FS8151, BYK® 375 and BYK® 349.

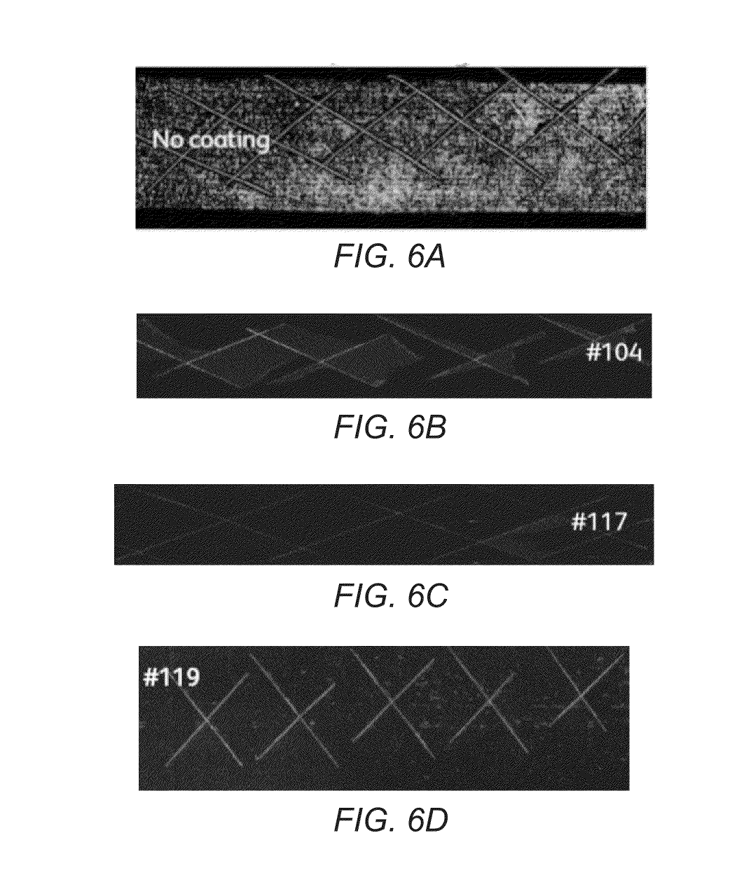

The effectiveness of colloidal silica in this application is illustrated in FIGS. 6A-6D. FIG. 6A shows a 100% black SIJ print image without any application of overprint coating after it has been subjected to an x-cut tape-peel test. The white areas denote regions where ink has been removed by the tape. One of the purposes of the overprint coating is to reduce the amount of ink removed by a tape peel test.

FIG. 6B shows a 100% black SIJ print image coated in-line with the surfactant-modified latex-based overcoat of comparative example 1B after it has been subjected to an x-cut tape-peel test. It is immediately obvious that the density of white areas is markedly reduced compared to FIG. 6A showing the improvement resulting from overprint coating. Careful inspection of FIG. 6B however shows regions along the x-cuts, and especially at the x interstices, where the coating film has been lifted from the print image. This indicates insufficient coating film adhesion.

### Example II

### Example IIA

| Component | Wet Weight % | Source |
|---|---|---|
| acrylic latex | 51 | BASF JONCRYL ® 74-A |
| | | (50 wt. % in solid) |
| paraffin/polyethylene | 14 | BASF JONCRYL ® |
| wax | | WAX 28 (38 wt. % in solid) |
| Commercially available | 28 | Coating and Adhesives |
| overcoat composition | | Corporation |
| Fluorinated surfactant | 5 | Innovative Chemical |
| | | Technologies, Inc |
| | | Thetawet FS 8050 |
| Colloidal Silica | 2 | Nissan Chemical |
| | | SNOWTEX-ZL |
| | | (48.5 wt. % in solid) |

The coating composition of Example IIA, containing selected surfactants and the adhesion agent of colloidal silica, was applied to the prints less than 2 minutes after printing/spreading as described above.

FIG. 6C shows a 100% black SIJ print image coated in-line with the surfactant-modified latex-based overcoat of comparative Example IIA after it has been subjected to an x-cut tape-peel test. It is observed that there is a significant improvement in the extent of regions of poor adhesion. This is attributed to the reinforcing effect of colloidal silica. While not intending to be bound by any particular theory, it is believed that the porosity and high oil absorption coefficient of the amorphous colloidal silica can effectively remove oil from the print image coating interface. Additionally, the amine moiety of the functionalized silicone oil can contribute to the gelation of the silica in a manner that reinforces interfacial adhesion.

### Example IIB

| Component | Wet Weight % | Source |
|---|---|---|
| acrylic latex | 48.4 | BASF JONCRYL ® 74-A |
| | | (50 wt. % in solid) |
| paraffin/polyethylene | 13.2 | BASF JONCRYL ® |
| wax | | WAX 28 (38 wt. % in solid) |
| Commercially available | 26.4 | Coating and Adhesives |
| overcoat composition | | Corporation |
| Surfactant | 10 | Innovative Chemical |
| | | Technologies, Inc |
| | | Thetawet FS 8050 |
| Colloidal Silica | 2 | Nissan Chemical |
| | | SNOWTEX-ZL |
| | | (48.5 wt. % in solid) |

The coating composition of Example IIA, containing selected surfactants and the adhesion agent of colloidal silica, was applied to the prints less than 2 minutes after printing/spreading as described above.

FIG. 6D shows a 100% black SIJ print image coated in-line with the surfactant-modified latex-based overcoat of comparative Example IIB, after it has been subjected to an x-cut tape-peel test. Comparative Example IIB is identical to Example IIA except, the surfactant level has been increased. Although isolated, small regions of tape removal may be observed, which are likely associated with coating defect, there was no evidence of coating film loss of adhesion associated with the x-cuts. This indicated that careful manipulation of both components of this disclosure, viz. surfactant to achieve wetting and lay-down uniformity plus colloidal silica to reinforce interfacial adhesion can achieve excellent results for in-line coating of SIJ prints.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applimayts/patentees and others. Unless specifically recited in a claim, steps or components of claims should not be implied or imported from the specification or any other claims as to any particular order, number, position, size, shape, angle, color, or material. All the patents and applications referred to herein are hereby specifically, and totally incorporated herein by reference in their entirety in the instant specification.

What is claimed is:

1. A coating composition for application over a printed substrate, the coating composition comprising:
a latex dispersion, a wax, at least one surfactant, and a colloidal silica, wherein the colloidal silica comprises a plurality of silica particles present in the coating composition in an amount such that the coating composition is sufficiently adhesive to the printed substrate comprising a solid ink jet (SIJ) ink image when dried.

2. The composition of claim 1, wherein the plurality of silica particles is present in an amount ranging from about 1 percentage to about 25 percentage by weight of a total coating composition.

3. The composition of claim 1, wherein the plurality of silica particles has an average particle size ranging from about 1 nm to about 1000 nm, measured by Malvern particle size analyzer.

4. The composition of claim 1, wherein the wax comprises wax powder having an average powder size ranging from about 10 nanometers to about 10 microns.

5. The composition of claim 1, wherein the wax is provided in a dispersion having a wax concentration ranging from about 5 percent to about 40 percent by weight of the total dispersion.

6. The composition of claim 1, wherein the wax comprises a polyolefin wax, non-ionic dispersion based on a paraffin wax, non-ionic dispersion based on an oxidized high density polyethylene wax, non-ionic aqueous dispersion of a polytetrafluoroethylene (PTFE) modified polyethylene wax, and combinations thereof.

7. The composition of claim 1, wherein the printed substrate has a low surface tension ranging from about 15 mN/m to about 35 mN/m.

8. The composition of claim 1, wherein the coating sufficiently adhesive to the printed substrate has substantially no pinholes.

9. The composition of claim 1, wherein the latex dispersion comprises a plurality of latex particulates present in an amount from about 5 percentage to about 95 percentage by weight of a total coating composition.

10. The composition of claim 1, wherein the surfactant or the colloidal silica or their combination is attached to a surface of latex particulates in the latex dispersion or physically adsorbed on a surface of latex particulates in the latex dispersion in a manner that is attributed and measured in terms of suitable thermodynamic parameters associated with a range of physic-chemical bonding mechanisms.

11. The composition of claim 1, wherein the surfactant comprises a fluorosurfactant, a silicone surfactant, or combinations thereof, the silicone surfactant comprising a polyether modified polydimethylsiloxane.

12. The composition of claim 1, wherein the latex dispersion comprises an acrylic dispersion comprising at least one member selected from the group consisting of poly(alkyl methacrylate-alkyl acrylate), poly(alkyl methacrylate-aryl acrylate), poly(aryl methacrylate-alkyl acrylate), poly(alkyl methacrylate-acrylic acid), poly(alkyl acrylate-acrylonitrile-acrylic acid), poly(styrene-alkyl acrylate), polystyrene-1,3-diene), poly(styrene-alkyl methacrylate), poly(styrene-alkyl acrylate-acrylic acid), polystyrene-1,3-diene-acrylic acid), poly(styrene-alkyl methacrylate-acrylic acid), poly(styrene-alkyl acrylate-acrylonitrile-acrylic acid), and poly(styrene-1,3-diene-acrylonitrile-acrylic acid).

13. A coating composition when coated on a printed substrate having a low surface tension ranging from about 15 mN/m to about 35 mN/m, the coating composition comprising:
a latex dispersion, a wax, at least one surfactant, and a colloidal silica, wherein the coating composition, when dried, has substantially no pinholes and is sufficiently adhesive to the printed substrate having the low surface tension.

14. The composition of claim 13, wherein the printed substrate comprises an SIJ ink image printed on at least one side of a substrate and a film of release agent applied at least on one portion of the SIJ ink image.

15. The composition of claim 13, wherein the colloidal silica comprises a plurality of silica particles present in an amount ranging from about 8 percentage to about 15 percentage by weight of a total coating composition.

16. The composition of claim 13, wherein the coating composition sufficiently adhesive to the printed substrate when dried coating composition has a thickness ranging from about 0.3 microns to about 10 microns.

17. The composition of claim 13, wherein the coating composition when dried is in an amount between about 0.3 gsm to about 10 gsm to the SIJ ink image.

18. An in-line printing system for creating durable solid ink jet (SIJ) ink images, the system comprising:
a spreader configured in an SIJ inkjet printing system to pass through a printed substrate comprising SIJ ink images on a substrate, wherein a film of release agent is applied at least on the SIJ ink images of the printed substrate, the printed substrate comprising a low surface tension ranging from about 15 mN/m to about 35 mN/m; and
a liquid film coating device configured to apply a coating composition to the printed substrate after exiting the spreader, wherein the coating composition comprises a surfactant and a colloidal silica such that the coating composition has substantially no pinholes on the printed substrate and a dried coating composition is sufficiently adhesive to the printed substrate having the low surface tension.

19. The system of claim 18, wherein the spreader and the liquid film coating device are configured to allow an in-line coating within 2 minutes after the printed substrate exiting the spreader.

20. The system of claim 18, wherein the SIJ inkjet printing system is capable of producing the SIJ ink images on two sides of the substrate and the liquid film coating device is configured to apply the coating composition to one or both sides of the printed substrate, and wherein the one or both sides of the printed substrate have the low surface tension.
